(19) United States
(12) Patent Application Publication
(10) Pub. No.: US 2008/0019563 A1
(43) Pub. Date: Jan. 24, 2008

(54) Mail processing system with low resolution UV imaging subsystem

(76) Inventors: Mark D. Goodwin, Apalachin, NY (US); Mathew S. Hale, Barton, NY (US)

Correspondence Address: Lockheed Martin Corporation;c/o WOLF, GREENFIELD & SACKS, P.C., 600 ATLANTIC AVENUE, BOSTON, MA, 02210-2206, US

(21) Appl. No.: 11/824,824

(22) Filed: Jul. 3, 2007

Related U.S. Application Data
(60) Provisional application No. 60/819,136, filed on Jul. 7, 2006.
(60) Provisional application No. 60/819,414, filed on Jul. 7, 2006.
(60) Provisional application No. 60/819,217, filed on Jul. 7, 2006.
(60) Provisional application No. 60/819,084, filed on Jul. 7, 2006.
(60) Provisional application No. 60/819,132, filed on Jul. 7, 2006.
(60) Provisional application No. 60/819,137, filed on Jul. 7, 2006.

(51) Int. Cl. G06K 9/00

(52) U.S. Cl. 382/101

(57) ABSTRACT

A mail processing system with a low resolution UV imaging subsystem. The subsystem comprises a detector array made with discrete phototransistors, each of which includes a lens. The phototransistors are mounted on a relatively wide pitch to provide a low resolution camera that can image an entire surface of a mailpiece. The camera can be constructed and maintained inexpensively, but can quickly provide information that facilitates rapid and accurate processing of mailpieces.

### CROSS-REFERENCE TO RELATED APPLICATIONS

This application claims the benefit under 35 U.S.C. § 119(e) of U.S. Provisional Application Ser. No. 60/819,136, filed Jul. 7, 2006, U.S. Provisional Application Ser. No. 60/819,414, filed Jul. 7, 2006, U.S. Provisional Application Ser. No. 60/819,217, filed Jul. 7, 2006, U.S. Provisional Application Ser. No. 60/819,084, filed Jul. 7, 2006, U.S. Provisional Application Ser. No. 60/819,132, filed Jul. 7, 2006, and U.S. Provisional Application Ser. No. 60/819,137, filed Jul. 7, 2006. Each of the above applications is incorporated herein by reference.

### FIELD OF INVENTION

This invention relates generally to mail processing systems and equipment used therein.

### BACKGROUND

The U.S. Postal Service (USPS) has developed standards for the marking of mailpieces that facilitate the automatic sorting and processing of such items. Such mailpiece features include stamps, meter marks, information based indicia (IBI) barcodes (PDF417 and Data Matrix), facing identification marks (FIM), Postal Numeric Encoding Technique (POSTNET) codes, postal alphanumeric encoding technique (PLANET) codes, 4CB codes, and identification (ID) tags. The purpose and use of such features are well known in the art and thus will not be described in detail.

Line scan cameras have been implemented in numerous industrial and commercial settings, such as on high-speed mail sorting systems. An example of a prior art mail sorting system that employed such cameras, as well as several other components, is illustrated in FIG. 1. As shown, the mail sorting system 2 comprised a singulation stage 4, a first indicia detection stage 6, a facing inversion stage 8, a second indicia detection stage 10, a cancellation stage 12, an inversion stage 14, an ID tag spraying stage 16, an image lifting stage 18, and a stacking stage 20. One or more conveyors (not shown) would move mailpieces 19 from stage to stage in the system 2 (from left to right in FIG. 1) at a rate of approximately 3.6-4.0 meters per second.

The singulation stage 4 included a feeder pickoff 22 and a fine cull 24. The feeder pickoff 22 would generally follow a mail stacker (not shown) and would attempt to feed one mailpiece at a time from the mail stacker to the fine cull 24, with a consistent gap between mailpieces. The fine cull 24 would remove mailpieces that were too tall, too long, or perhaps too stiff. When mailpieces 19 left the fine cull 24, they would ideally be in one of four possible orientations, as illustrated by mailpieces 19a-d.

Each of the first and second indicia detection stages 6, 10 included a pair of indicia detectors 26a-b, 26c-d positioned to check the lower edges (of approximately one inch) of the opposite faces of a passing mailpiece 19 for reactance to ultraviolet (UV) radiation and for FIM marks, and thereby detect indicia at such locations. As used herein, “indicia” refers to any marking on a mailpiece that represents a postage value. If the first indicia detection stage 6 failed to detect any indicia on either lower edge of a given mailpiece, that mailpiece would be inverted by an inverter 9 at the facing inversion stage 10 so as to allow the second indicia detection stage 10 to check the lower one inch edges of the other side of the mailpiece for indicia. As a result, each mailpiece 19 that had detectable indicia thereon ideally ended up positioned with the edge containing the indicia (the “top edge” of the mailpiece) facing downward after it left the second indicia detection stage 10, with at least one of the indicia detectors 26a-d having identified the face of the mailpiece that contained the indicia.

The cancellation stage 12 included a pair of cancellers 28a-b arranged to spray one side of the top edge of the mailpiece (i.e., the side determined to contain the indicia), and thereby cancel the indicia. Following the cancellation stage 12, each mailpiece would be inverted by an inverter 15 at the inversion stage 14 so that the top edge of the mailpiece was made to face upwards. The ID tag spraying stage 16 included a pair of ID tag sprayers 30a-b arranged to spray an ID tag, as needed, along an appropriate one of the two lower edges of the mailpiece, as determined by the facing decision made by the indicia detection stages 6, 10.

The image lifting stage 18 included a pair of line scanning cameras 32a-b that imaged the mailpiece. Each line scanning camera provided a two hundred and twelve pixel per inch (PPI) image for address recognition. An analysis of the accumulated images facilitated a determination of the one of several output bins 34a-g of the stacking stage 20 into which the mailpieces was to be stacked based on certain criteria.

### SUMMARY

In one aspect, the invention relates to a method of processing mailpieces. A surface of a mailpiece is illuminated with ultraviolet radiation. Light emanating from the mailpiece in response to the ultraviolet radiation is captured using an array of detectors. An image of the surface of the mailpiece is formed and analyzed to determine whether a feature on the surface of the mailpiece responds to ultraviolet radiation. The image analysis is used to control processing of the mailpiece.

In another aspect, the invention relates to a method of processing mailpieces. A mailpiece is moved past an array of detectors. Portions of a surface of the mailpiece are illuminated with ultraviolet radiation and the array of detectors is used to capture light emanating from the mailpiece in response to the ultraviolet radiation. A two-dimensional image of the surface of the mailpiece is formed using the captured light. The image is analyzed to detect a feature on the surface of the mailpiece that responds to ultraviolet radiation.

In yet a further aspect, the invention relates to a mail processing system that includes an ultraviolet imaging subsystem to form an image of a mailpiece in an imaging area. The ultraviolet imaging subsystem has a source of ultraviolet light directed toward the imaging area. An array of photodetectors is also directed at the imaging area. The subsystem includes an interface adapted to provide an image captured by the array of photodetectors to a data processing system.

### BRIEF DESCRIPTION OF THE DRAWINGS

FIG. 1 is a diagram of a prior art mail sorting system;

FIG. 2 is a diagram of an illustrative example of a mail sorting system in which embodiments of the invention may be implemented;

FIG. 3 is a diagram of another illustrative example of a mail sorting system in which embodiments of the invention may be implemented;

FIG. 4 shows a partial-cutaway, perspective view of the image lifting stage of the system shown in FIGS. 2 and 3;

FIG. 5 shows a top view of the image lifting stage shown in FIG. 4;

FIG. 6 shows a partial-cutaway, perspective view of one of the camera assemblies shown in FIG. 4;

FIG. 7 shows a top view of the camera assembly shown in FIG. 6;

FIG. 8 shows an exploded view of the camera assembly shown in FIG. 6;

FIG. 9 shows an exploded view of the nose assembly portion of the camera assembly shown in FIG. 6;

FIG. 10 shows a partial-cutaway, perspective view of the base assembly portion of the camera assembly shown in FIG. 6;

FIGS. 11 and 12 show a low-resolution UV image of a mailpiece with a UV-reactive meter mark and a grayscale image of the same mailpiece, respectively, which images were taken by a camera assembly like that shown in FIG. 6;

FIGS. 13 and 14 show a UV image of a mailpiece with a UV-reactive IBI barcode and a grayscale image of the same mailpiece, respectively, which images were taken by a camera assembly like that shown in FIG. 6;

FIGS. 15 and 16 show a UV image of a mailpiece with a UV-reactive ID tag and a grayscale image of the same mailpiece, respectively, which images were taken by a camera assembly like that shown in FIG. 6;

FIG. 17 is a sketch of a UV imaging subsystem according to an embodiment of the invention;

FIG. 18 is a flowchart depicting processing of a mailpiece according to an embodiment of the invention; and

FIG. 19 is a sketch showing construction of a photodetector array according to an embodiment of the invention.

### DETAILED DESCRIPTION

We have appreciated that existing mail processing equipment could be improved with improved and differently organized system components. Improvements in the type and organization of components may, for example, increase the speed or accuracy with which mail is sorted. Additionally, improvements may reduce the overall cost and increase the reliability of mail processing equipment.

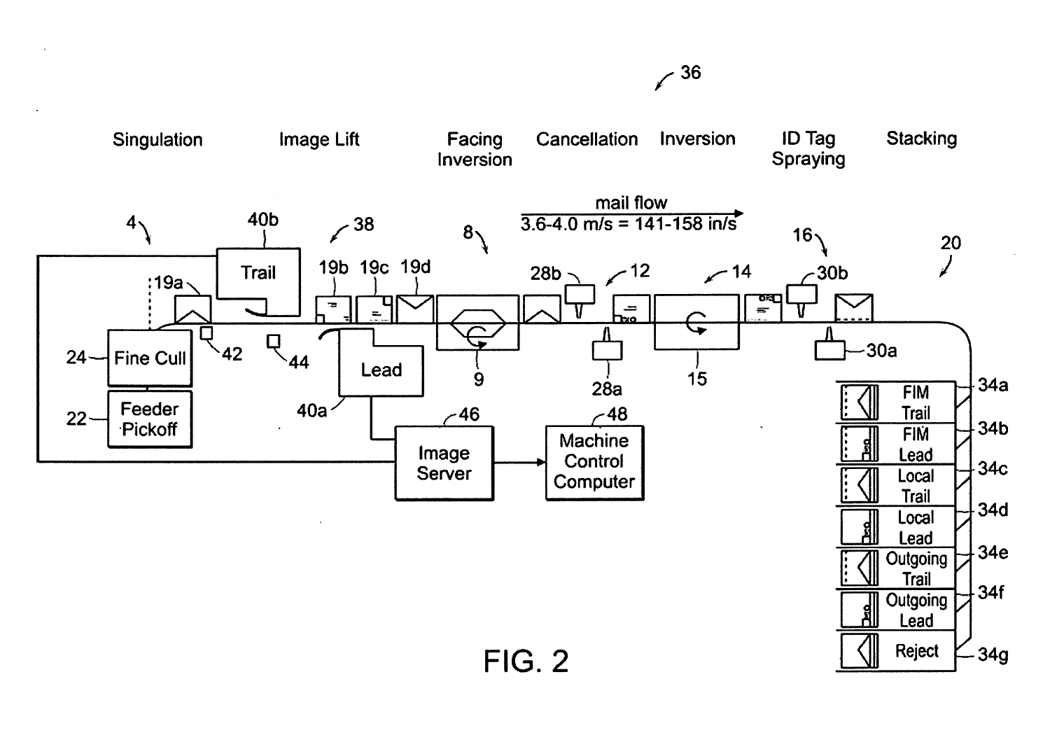

An illustrative example of a mail processing system embodying improved and differently organized components is shown in FIG. 2. In this example, the mail processing system is a mail sorting system in which mailpieces are carried through the system on a mail conveyor, such as a belt or series of belts. As mailpieces pass through the system, they are imaged. The image information may be used for routing the mailpieces to appropriate output locations. In addition, the image information may be used within the mail sorting system for tasks such as determining whether postage is affixed, locating indicia to which a cancellation mark is applied, or positioning a bar code or similar markings on the mailpiece or determining of other markings, features and characteristics of the mailpiece.

Details concerning the structure and operation of mail processing systems according to some embodiments are provided in Application Ser. No. 60/819,136, entitled MULTIPLE ILLUMINATION SOURCES TO LEVEL SPECTRAL RESPONSE FOR MACHINE VISION CAMERA and bearing attorney docket nos. L0562.70061US00 and Application Ser. No. 60/819,084, entitled SYNCHRONIZATION OF STROBED ILLUMINATION WITH LINE SCANNING OF CAMERA and bearing attorney docket nos. L0562.70064US00. Both of which are filed on even date herewith and are incorporated herein by reference in their entireties.

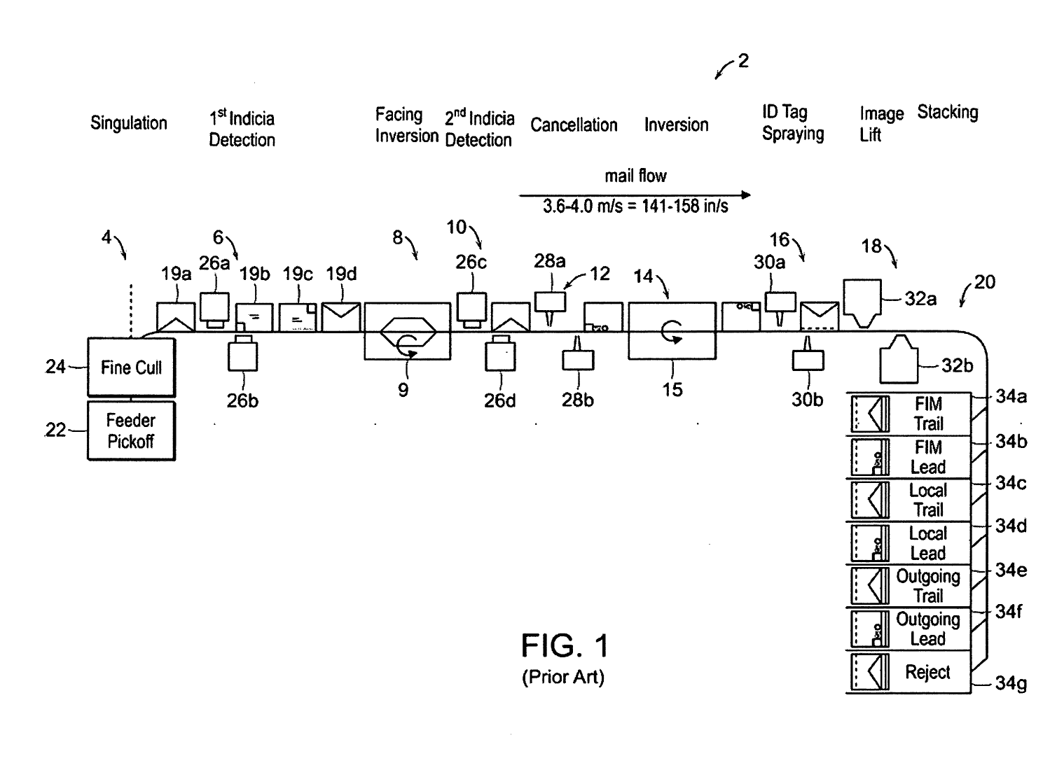

As shown, mail sorting system 36 of FIG. 2 is similar to the mail sorting system 2 of FIG. 1 insofar as it comprises a singulation stage 4, a facing inversion stage 8, a cancellation stage 12, an inversion stage 14, an ID tag spraying stage 16, and a stacking stage 20. In contrast to the system 2, however, in the system 36, all of the functionality of the first indicia detection stage 6, the second indicia detection stage 10, and the image lifting station 18 may be achieved by a single pair of camera assemblies 40a-b (described in more detail below) included in an image lifting stage 38. As shown, the image lifting stage 38 is located between the singulation stage 4 and the facing inversion stage 8 of the system 36, but image lifting stage 38 may be incorporated into system 36 in any suitable location.

In operation, each of the camera assemblies 40a-b acquires both a low-resolution UV image and a high-resolution grayscale image of a respective one of the two faces of each passing mailpiece 19. Because the UV images are of the entire face of the mailpiece, rather than just the lower one inch edge, there is no need to invert the mailpiece when making a facing determination.

Each of the camera assemblies illustrated in FIG. 2 is constructed to acquire both a low-resolution UV image and a high-resolution grayscale image, and such assemblies may be used in embodiments of the invention. It should be appreciated, however, the invention is not limited in this respect. Components to capture a UV image and a grayscale image may be separately housed in alternative embodiments. It should be further appreciated that the invention is not limited to embodiments with two or more camera assemblies as shown. A single assembly could be constructed with an opening through which mailpieces may pass, allowing components in a single housing to form images of one or multiple faces of a mailpiece. Similarly, optical processing, such as through the use of mirrors, could allow a single camera assembly to capture images of one or multiple faces of a mailpiece.

Further, it should be appreciated that UV and grayscale are representative of the types of image information that may be acquired rather than a limitation on the invention. For example, a color image may be acquired. As another example, an acquired image may be binarized for processing in some embodiments. In those embodiments, grayscale information need not be collected or retained and each image pixel may be simply represented by a single digital value. Consequently, any suitable imaging components may be included in system 36.

As shown, the system 36 may further include an item presence detector 42, a belt encoder 44, an image server 46, and a machine control computer 48. The item presence detector 42 (examples of an item presence detector are a “photo eye” or a “light barrier”) may be located, for example, five inches upstream of the trail camera assembly 40b, to indicate when a mailpiece is approaching. The belt encoder 44 may output pulses (or “ticks”) at a rate determined by the travel speed of the belt. For example, the belt encoder 44 may output two hundred and fifty six pulses per inch of belt travel. The combination of the item presence detector 42 and belt encoder 44 thus enables a relatively precise determination of the location of each passing mailpiece at any given time. Such location and timing information may be used, for example, to control the strobing of light sources in the camera assemblies 40a-b to ensure optimal performance independent of variations in belt speed.

Image information acquired with the camera assemblies 40a-b or other imaging components may be processed for control of the mail sorting system or for use in routing mailpieces passing through the system 36. Processing may be performed in any suitable way with one or more processors. In the illustrated embodiment, processing is performed by image server 46.

The image server 46 may receive image data from the camera assemblies 40a-b, and process and analyze such data to extract certain information about the orientation of and various markings on each mailpiece. In some embodiments, for example, images may be analyzed using a neural network, a pattern analysis algorithm, or a combination thereof. Either or both of the grayscale images and the UV images may be so processed and analyzed, and the results of such analysis may be used by other components in the system 36, or perhaps by components outside the system, for sorting or any other purpose.

In the embodiment shown, information obtained from processing images is used for control of components in the system 36 by providing that information to a separate processor that controls the system. The information obtained from the images, however, may additionally or alternatively be used in any other suitable way for any of a number of other purposes. In the pictured embodiment, control for the system 36 is provided by a machine control computer 48. Though not expressly shown, the machine control computer 48 may be connected to any or all of the components in the system 36 that may output status information or receive control inputs. The machine control computer 48 may, for example, access information extracted by the image server 46, as well as information from other components in the system, and use such information to control the various system components based thereupon.

Details concerning particular algorithms executed by the image server 46 and other hardware or firmware in the system are provided in application Ser. Nos. 11/482,386, 11/482,418, 11/482,421, 11/482,423, and 11/482,561, filed on even date herewith, respectively entitled DETECTION AND IDENTIFICATION OF POSTAL INDICIA, SYSTEM AN METHOD FOR REAL-TIME DETERMINATION OF THE ORIENTATION OF AN ENVELOPE, ARBITRATION SYSTEM FOR DETERMINING THE ORIENTATION OF AN ENVELOPE FROM A PLURALITY OF CLASSIFIERS, DETECTION AND IDENTIFICATION OF POSTAL METERMARKS, POSTAL INDICIA CATEGORIZATION SYSTEM, and bearing attorney docket nos., LM(F)8227, LM(F)8228, LM(F)8229, LM(F)8230, LM(F)8231. Each of the foregoing applications is incorporated herein by reference in its entirety.

In the example shown, the camera assembly 40a is called the “lead” assembly because it is positioned so that, for mailpieces in an upright orientation, the indicia (in the upper right hand corner) is on the leading edge of the mailpiece 19 with respect to its direction of travel. Likewise, the camera assembly 40b is called the “trail” assembly because it is positioned so that, for mailpieces in an upright orientation, the indicia is on the trailing edge of the mailpiece with respect to its direction of travel. Upright mailpieces themselves are also conventionally labeled as either “lead” or “trail” depending on whether their indicia is on the leading or trailing edge with respect to the direction of travel.

Following the last scan line of the lead camera assembly 40a, the image server 46 may determine an orientation of “flip” or “no-flip” for the inverter 9. In particular, the inverter 9 is controlled so that that each mailpiece 19 has its top edge down when it reaches the cancellation stage 12, thus enabling one of the cancellers 28a-b to spray a cancellation mark on any indicia properly affixed to a mailpiece by spraying only the bottom edge of the path (top edge of the mailpiece). The image server 46 may also make a facing decision that determines which canceller (lead 28a or trail 28b) should be used to spray the cancellation mark. Other information recognized by the image server 46, such as IBI, may also be used, for example, to disable cancellation of IBI postage since IBI would otherwise be illegible downstream.

After cancellation, all mailpieces may be inverted by the inverter 15, thus placing each mailpiece 19 in its upright orientation. Immediately thereafter, an ID tag may be sprayed using one of the ID tag sprayers 30a-b that is selected based on the facing decision made by the image server 46. In some embodiments, all mailpieces with a known orientation may be sprayed with an ID tag. In other embodiments, ID tag spraying may be limited to only those mailpieces without an existing ID tag (forward, return, foreign).

Following application of ID tags, the mailpieces 19 may ride on extended belts for drying before being placed in output bins or otherwise routed for further processing. In the example shown, there are seven output bins 34a-g. Except for rejects (bin 34g), the output bins 34a-f are in pairs to separate lead mailpieces from trail mailpieces. It is desirable for the mailpieces 19 in each output bin to face identically. The operator may thus rotate trays properly so as to orient lead and trail mailpieces the same way. The mail may be separated into four broad categories: (1) FIM A&C (FIM with POSTNET), (2) outgoing (destination is a different SCF), (3) local (destination is within this SCF), and (4) reject (detected double feeds, not possible to sort into other categories). The decision of outgoing vs. local, for example, may be based on the image analysis performed by the image server 46.

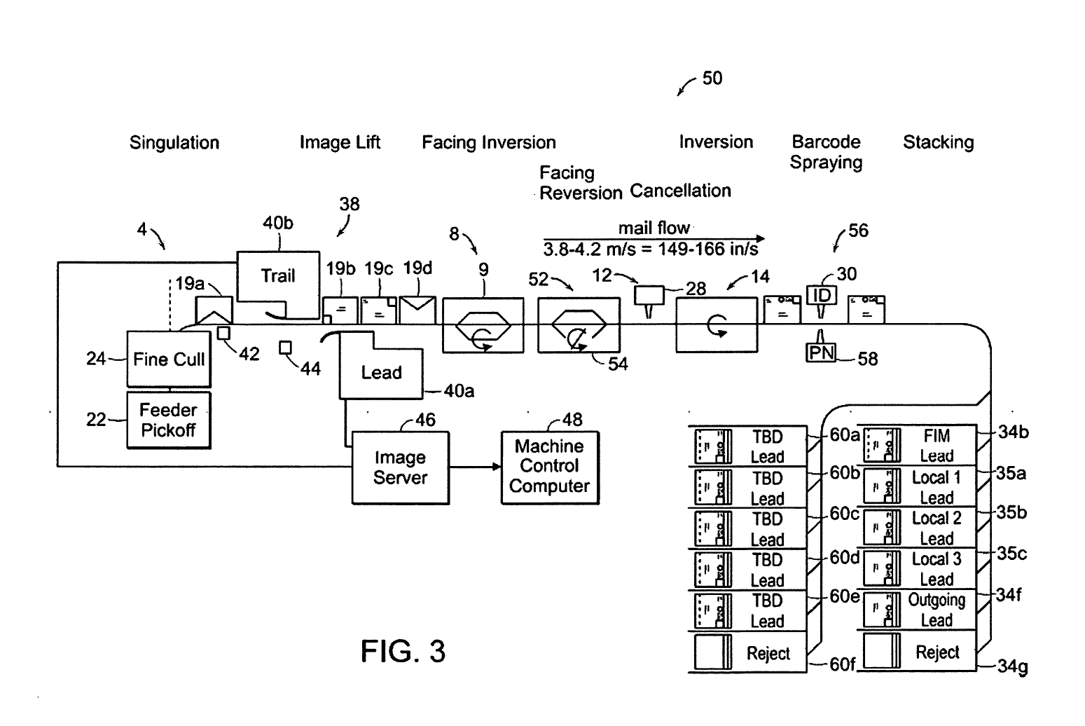

FIG. 3 shows another illustrative example of a mail sorting system embodying various aspects of the invention. The system 50 of FIG. 3 is similar to the system 36 of FIG. 2, but there are a few significant differences. One such difference is that the system 50 includes a facing reversion stage 52 (including a reverser 54) in addition to the facing inversion stage 8. The reverser 54 may be used to ensure that all mailpieces 19 are in the same orientation before they reach the cancellation stage 12 by selectively reversing (flipping horizontally) those mailpieces that are facing opposite the desired direction. Because all mailpieces are known to have the same orientation when they reach the cancellation stage 12, it is possible to employ only a single cancellation sprayer 28 in that stage.

Another difference between the system 50 of FIG. 3 and the system 36 of FIG. 2 is that, in the system 50, a barcode spraying stage 56 includes a single ID tag sprayer 30 as well as a single POSTNET sprayer 58, whereas, in the system 30, the ID tag spraying stage 16 included a pair of ID tag sprayers 30a-b. Again, the provision of the facing reversion stage 52 enables only a single sprayer of each type to be employed, because the precise orientation of all passing mailpieces 19 is known (i.e., they are all in a lead orientation).

Because it is known that all mailpieces are in a lead orientation, there is also no need for separate bins for lead and trail mailpieces, like in the embodiment of FIG. 2. In the example shown, three separate local lead bins 35a-c are employed in lieu of the trail bins 34a, 34c, and 34e of the system 36, thus enabling a finer level of sorting of local mail by the system 50. The system 50 also includes several additional output bins 60a-f into which mail can be sorted depending on the analysis done by the image server 46 on UV and/or grayscale images accumulated by the camera assemblies 40a-b.

As illustrated by the embodiments of a mail processing system shown in FIGS. 2 and 3, it is desirable for decisions to be made as a mailpiece passes through the system. The speed and accuracy with which the information to make such decisions can be acquired and processed can impact the overall speed and accuracy of the entire mail processing system. In the illustrated embodiments, both the speed and accuracy of mail processing is improved with an improved image lifting stage 38.

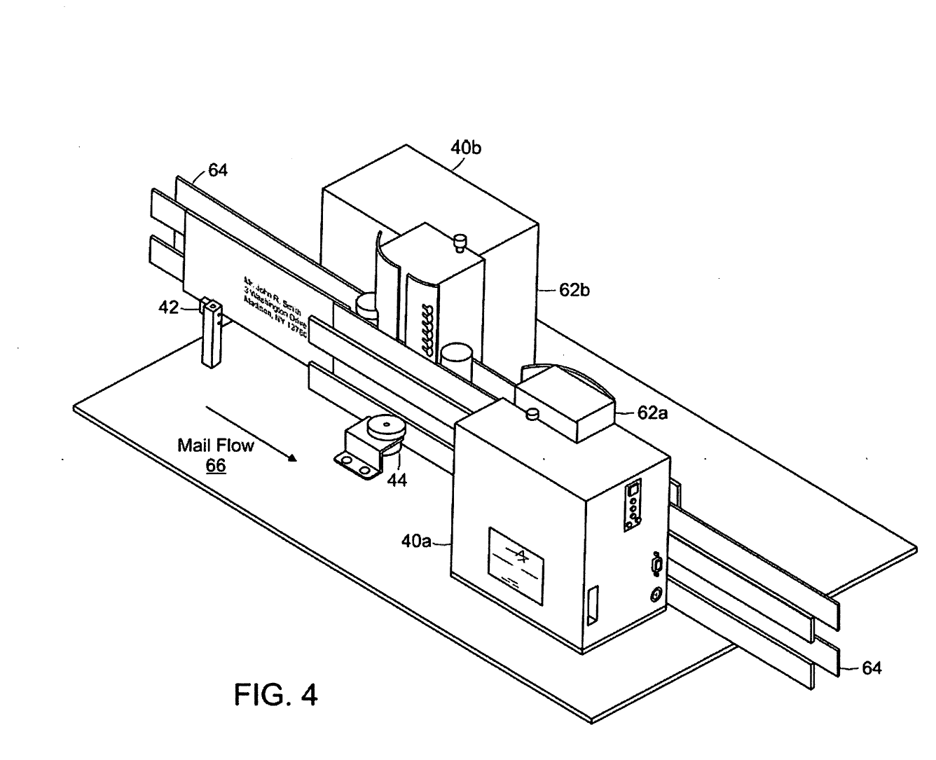

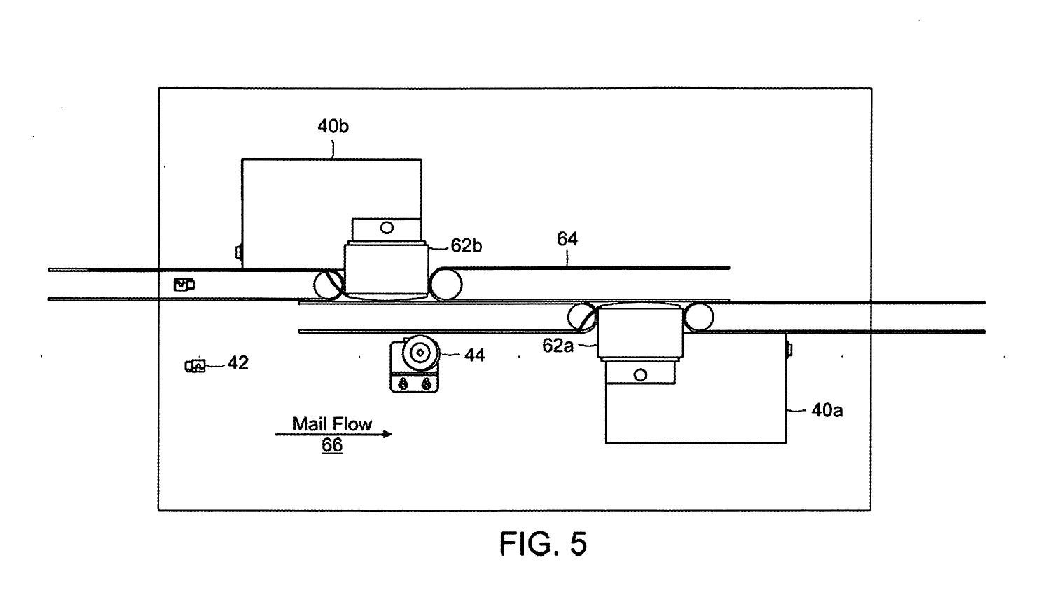

FIGS. 4 and 5 shown perspective and top views of an illustrative example of an improved image lifting stage 38 that may be used in the systems illustrated in each of FIGS. 2 and 3 or in other suitable mail processing applications. In FIG. 4, portions of the housings for the camera assemblies 40a-b have been removed. As shown, several conveyor belts 64 are arranged to move a mailpiece 19 past nose assemblies 62a-b of the camera assemblies 40a-b in the direction of the arrow 66 so that the camera assemblies 40a-b can acquire images thereof. Ideally, the faces of the mailpieces 19 are caused to maintain physical contact with the front portions of the nose assemblies 62a-b during the imaging process so that the distance between the camera and the mailpiece is kept constant.

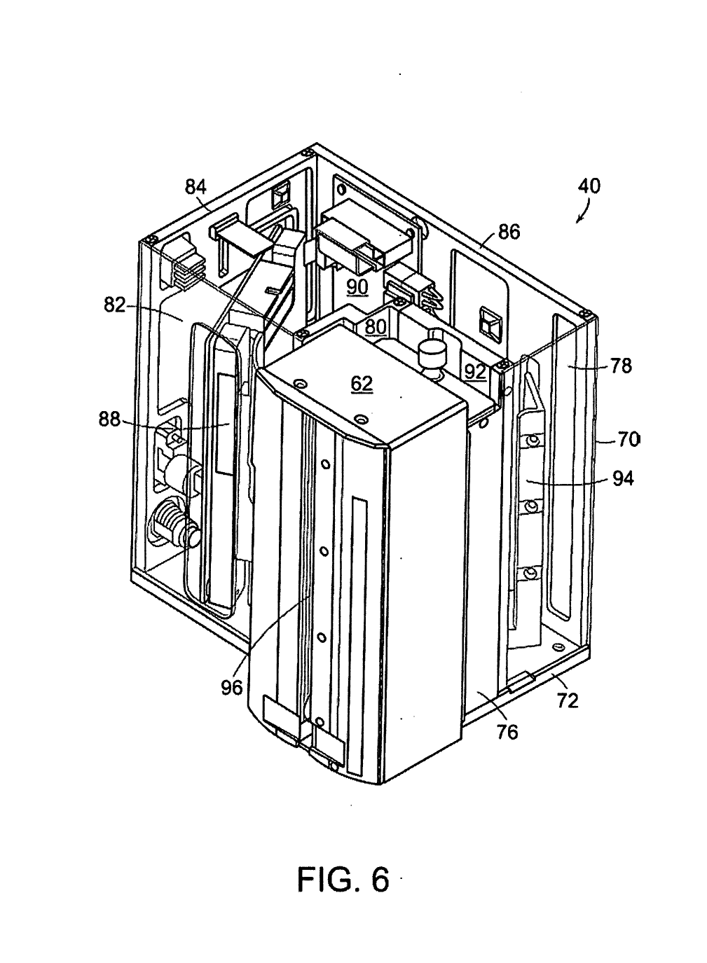

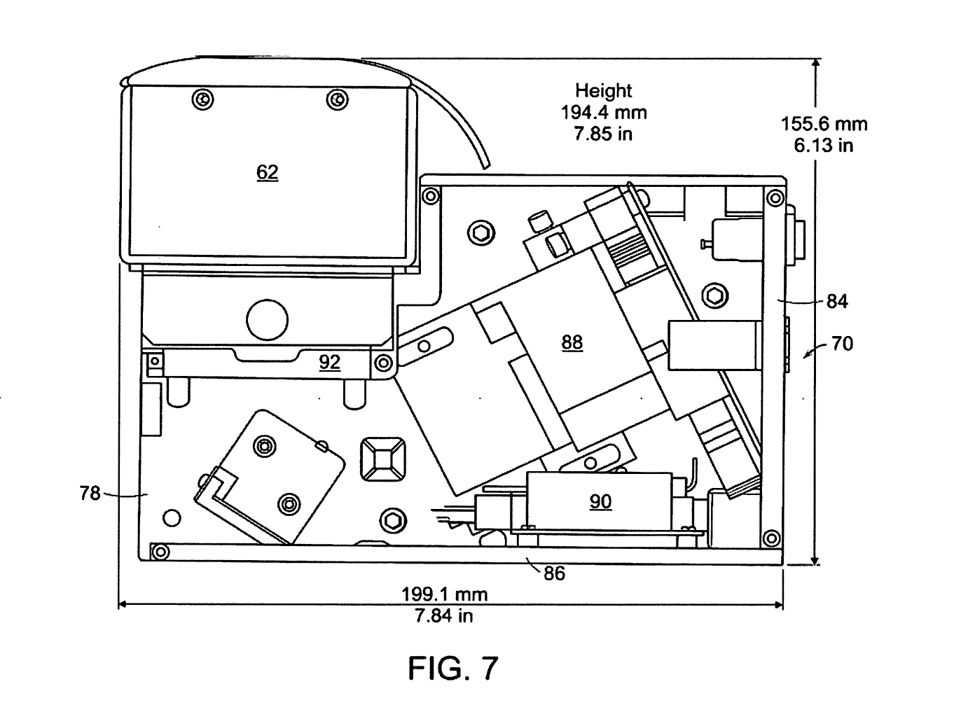

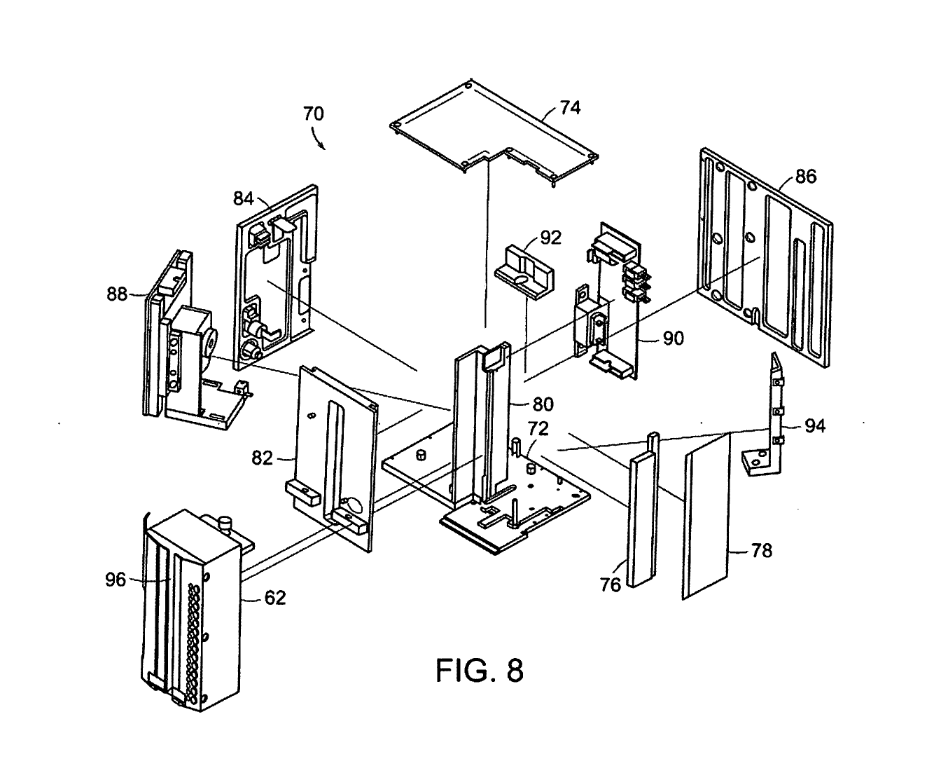

Several views of an illustrative embodiment of a camera assembly 40, and components thereof, are shown in FIGS. 6-10. As shown, each camera assembly 40 may comprise a nose assembly 62 detachably mounted to a base assembly 70. The base assembly 70 may comprise a housing formed of a base plate 72, top cover 74, and panels 76, 78, 80, 82, 84, 86. These panels may act as a housing to enclose the components of the assembly. These panels may additionally or alternatively serve as part of the support structure for components of the assembly.

In the example shown, enclosed within the housing are an optical bench assembly 88, a camera interface board (CIB) 90, a connector 92 for the nose assembly 62, and a mirror assembly 94. The optical bench assembly may, for example, contain an imaging array, such as a charge coupled device (CCD) (not shown), that produces lines of a grayscale image representative of the intensity of light transmitted through a slit 96 in the front of the nose assembly 62 and reflected from the mirror 94 onto the CCD of the optical bench assembly 88. Since the structure and function of the optical bench assembly 88 is essentially the same as that described in United States Application Publication No. 2006/0120563 A1, which is incorporated herein by reference in its entirety, the details of that structure will not be further described. It should be appreciated, however, that any of the other features or functionality of the camera assemblies, components thereof, and systems described in that published application may additionally or alternatively be employed in connection with various embodiments of the camera assemblies and overall system described herein.

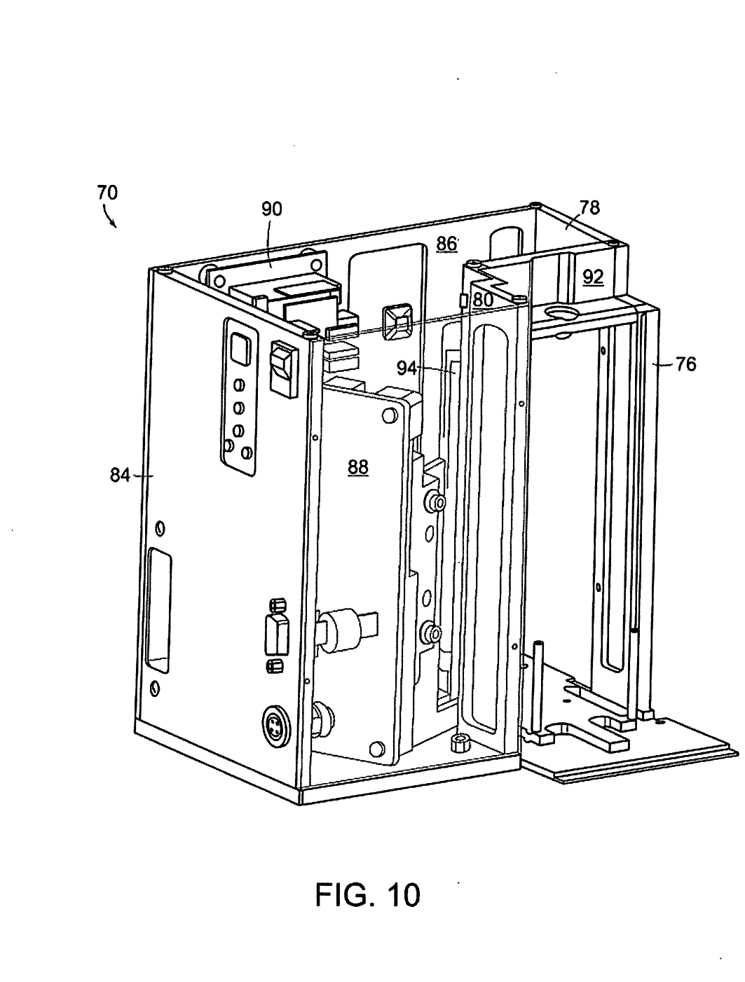

The CIB 90 may provide an electrical and communications link amongst the optical bench assembly 88, the nose assembly 62, and external devices (not shown in FIGS. 6-10). Such external devices may, for example, communicate with the camera assembly components via ports on the back panel 84 (see FIG. 10). The CIB 90 may, for instance, communicate UV and/or grayscale image data to the image server 46 (see FIGS. 2 and 3) via one or more Cameralink connections. In some embodiments, moreover, the CIB 90 may receive inputs from the item presence detector 42 and belt encoder 44 (shown in FIGS. 2 and 3), and selectively control activation of illumination sources and image acquisition components so as to accurately acquire high-quality images of a proper resolution, independent of changes in belt speed.

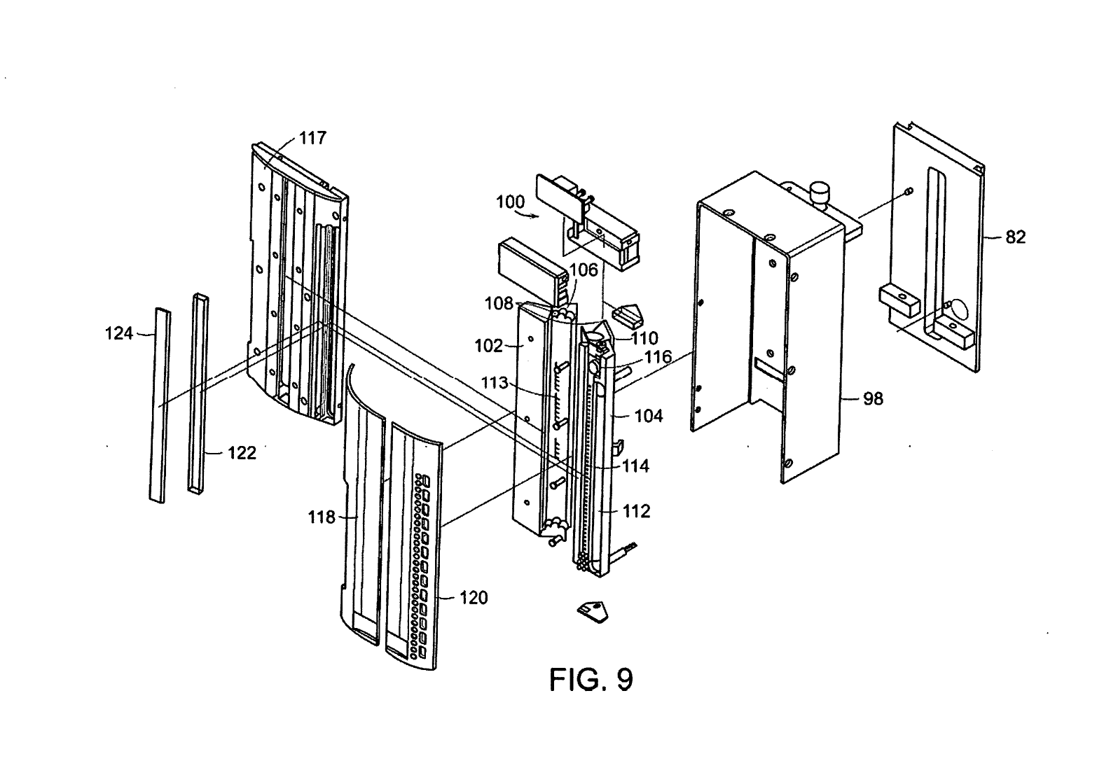

FIG. 9 shows an exploded view of an illustrative embodiment of the nose assembly 62. As shown, the nose assembly 62 may comprise a housing 98 in which are disposed a power supply 100 for a source of UV radiation 112 (discussed below), and a pair of aluminum support members 102, 104 having various components disposed thereon. In the example shown, the support member 102 supports a light source, which is here shown as an LED assembly 106. LED assembly 106 may be constructed from a circuit board or other suitable substrate having disposed thereon a large number of light emitting diodes (LEDs) 108. Likewise the support member 104 may support a similar LED assembly 110, which may also contain a circuit board and may also having a large number of LEDs 108 disposed thereon. The LED assemblies 106, 110 may be identical, but such is not required. In the illustrative embodiment shown, twenty nine rows of three LEDs 108 are disposed on each of the LED assemblies 106, 110, and a diffuser 113 is disposed in front of each group of eighty seven LEDs 108. In some embodiments, LEDs of different colors may be included amongst the white LEDs, and in some embodiments may be selectively controlled, so as to improve the response spectrum of the camera system.

As shown, the aluminum support member 104 may also support a source of UV radiation 112 and an array of phototransistors 114 arranged to receive light reflected from a mailpiece exposed to UV radiation from the source 112. In the example shown, the UV radiation source 112 is a florescent tube, but a set of UV generating diodes, or any other UV generating means, could alternatively be employed as the source of UV radiation 112. In some embodiments, the phototransistors 114 (or some other simple photon receptors) each contain an integrated lens, thus eliminating the need for focusing and calibration. Additional details concerning the structure and operation of the UV radiation source 112 and phototransistors 114 are provided below. Moreover, details concerning the control of the UV radiation source 112 so that it is shut off during periods of non-use of the system or when the housing assembly is opened or has been compromised are provided in Application Ser. No. 60/819,414, entitled MAIL IMAGING SYSTEM WITH UV ILLUMINATION INTERRUPT, bearing attorney docket number L0562.70062US00, and filed on even date herewith, which is incorporated herein by reference in its entirety. In the example shown, analog outputs of the phototransistors 114 are provided to an analog-to-digital converter (ADC) 116 where they are converted to a digital signal prior to being fed to the CIB 90 for further processing.

In the embodiment shown, the aluminum support members 102, 104 and associated components are covered by a platen 117 having a specialized configuration. The platen 117, in turn, is covered by a pair of wear plates 118, 120 also having a specialized design. Details concerning the specialized structure and function of the platen 117 and wear plates 118, 120 are provided in Application Ser. No. 60/819,217, entitled MAIL IMAGING SYSTEM WITH SECONDARY ILLUMINATION/IMAGING WINDOW, bearing attorney docket number L0562.70063US00, and filed on even date herewith, which is incorporated herein by reference in its entirety.

As shown, the UV radiation source 112 and array of phototransistors 114 may each be covered by a respective filter 122, 124 to enhance the accuracy of the UV image acquisition. In the embodiment shown, performance is enhance by placing a short pass filter 122 (allowing UV radiation to pass and blocking visible illumination) in front of the UV radiation source 112, and placing a long pass filter (allowing visible radiation to pass and blocking UV radiation) in front of the array of phototransistors 114. Additional details concerning the mechanisms and techniques used to filter the light generated by the UV radiation source 112 and received at the array of phototransistors 114 are provided in Application Ser. No. 60/819,132, entitled MAIL PROCESSING SYSTEM WITH RADIATION FILTERING, bearing attorney docket number L0562.70065US00 and filed on even date herewith, which is incorporated herein by reference in its entirety.

The radiation source 112 and array of phototransistors 114 may be arranged so that their operation does not interfere with the operation of optical bench assembly 88 in acquiring grayscale images. Advantageously, however, because they are acquired by components within the same camera assembly 40, the UV images and grayscale images acquired by the different components can be correlated with one another to facilitate the identification of the various markings on scanned mailpieces. Additional details concerning the acquisition and use of dual images by a camera assembly 40 and related components are provided in Application Ser. No. 60/819,137, entitled MAIL PROCESSING SYSTEM WITH DUAL CAMERA ASSEMBLY, bearing attorney docket number L0562.70066US00 and filed on even date herewith, which is incorporated herein by reference in its entirety.

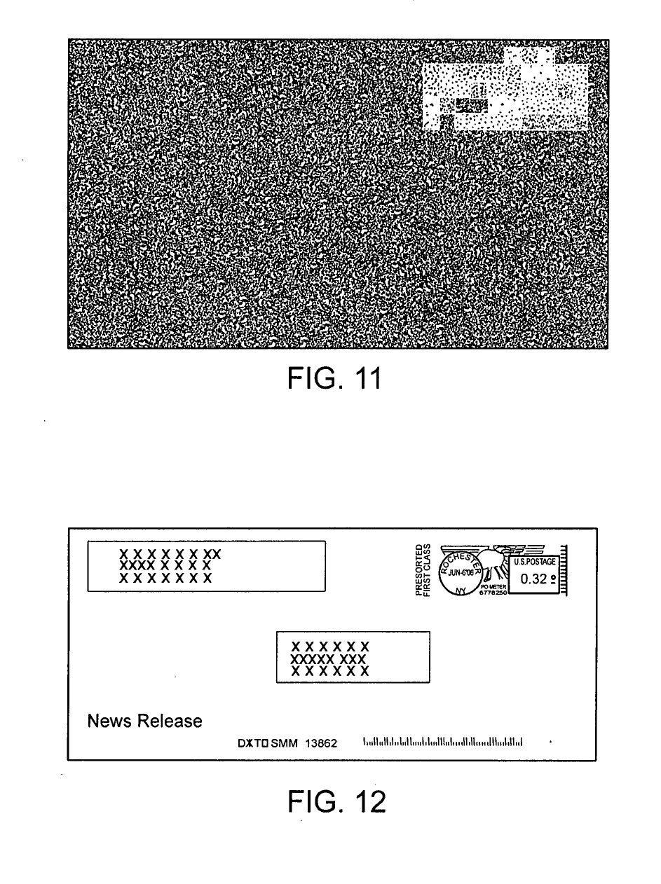

Examples of UV and grayscale images acquired of mailpieces by one of the camera assemblies 40 are shown in FIGS. 11-16, with names and addresses redacted where legible. In particular, FIG. 11 shows a low-resolution UV image of a mailpiece in which a region 1110 representing a UV-reactive meter mark is visible. FIG. 12 shows a grayscale image of the same mailpiece with a region 1210 representing the UV-reactive meter mark. Regions 1110 and 1210 differ in the type of information they present. Region 1110, appearing in a UV image, contains pixels with values representing the intensity of light emanating from the UV-reactive meter mark as a result of reaction with UV light. In contrast, region 1210 contains pixels with values representing the pattern of visible light reflecting from the UV-reactive meter mark.

Additionally, regions 1110 and 1210 differ in resolution. The grayscale image of FIG. 12 has higher resolution than the UV image of FIG. 11. In the example provided by FIG. 11 and FIG. 12, higher spatial resolution is apparent because individual pixels are discernable in FIG. 11 as the relatively large square regions of uniform color. In contrast, the pixels in FIG. 12 are approximately 25 times smaller, resulting in pixels that are so small that the boundaries of individual pixels are not readily discernable.

Despite the difference in resolution, the UV image and the grayscale image both represent a relatively large field of view. In a mail processing system, the field of view may be sufficiently large that, as mailpieces of the size the machine is designed to accept pass through the mail processing system, any portion of a mailpiece that could contain information to be analyzed by imaging will pass through the field of view. A desired size of the field of view of a camera therefore may depend on the nature of the mailpieces that are to be processed. Nonetheless, in this context, a camera that has a field of view large enough to encompass the desired areas of a mailpiece of a size mail processing equipment is designed to process can be said to image an entire surface of the mailpieces. As depicted, both the UV and grayscale cameras image the entire surface of a mailpiece.

In an embodiment, the UV image is used only to identify the presence of a feature and determine its location. An image with the resolution of the image of FIG. 11 is adequate for this purpose and can be formed with small and low cost components. The grayscale image of FIG. 12 may be analyzed to extract information from features, such as to recognize characters in an address or determine the denomination of a stamp. Higher resolution of the image of FIG. 12 facilitates the extraction of information.

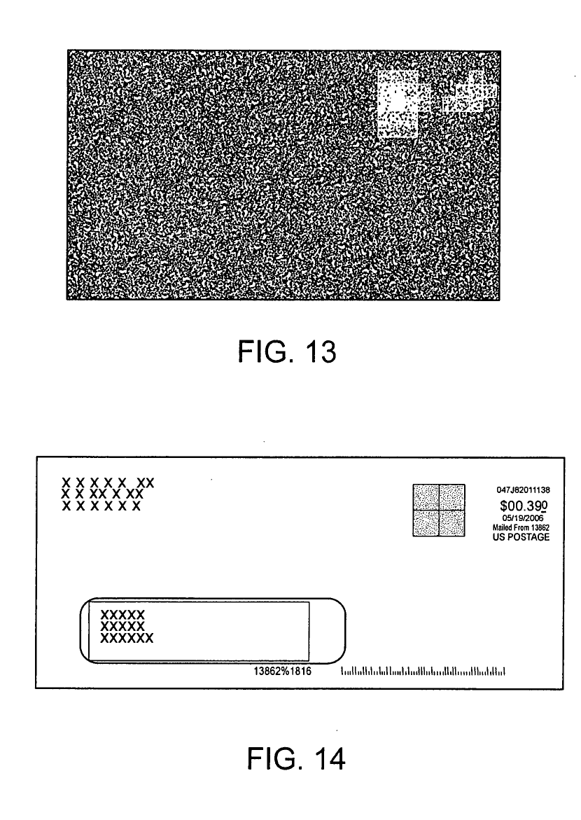

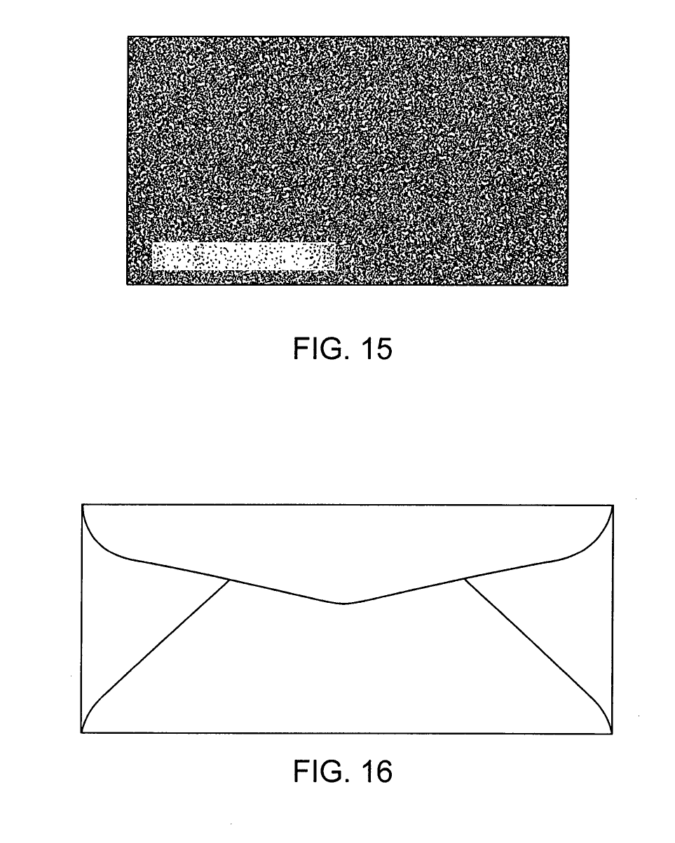

As another example, FIG. 13 shows a UV image of a mailpiece with a region 1310 representing a UV-reactive IBI barcode. FIG. 14 shows a grayscale image of the same mailpiece with a region 1410 representing the same feature. As a further example, FIG. 15 shows a UV image of a mailpiece with a region 1510 representing a UV-reactive ID tag, and FIG. 16 shows a grayscale image of the same mailpiece with a region 1610 representing the same feature. In the image of FIG. 16, the UV-reactive ID tag is barely visible and may not be detectable in a grayscale image. Such a feature may be detectable only in a UV image.

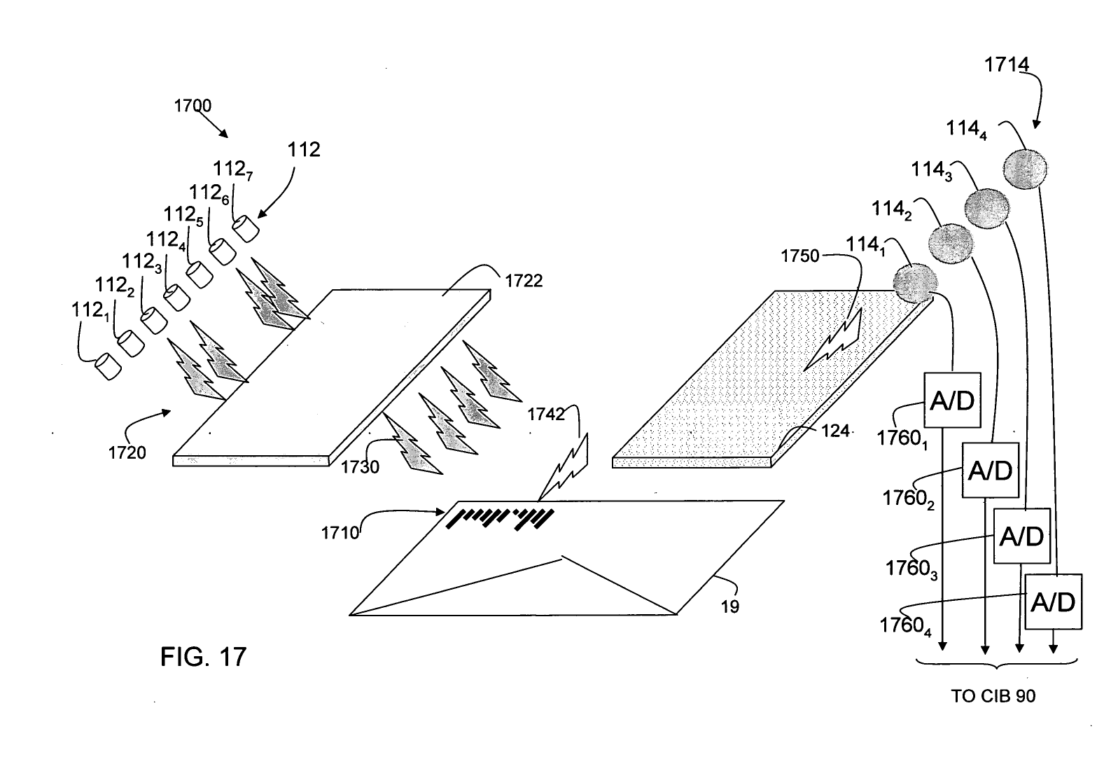

FIG. 17 illustrates an embodiment of a UV imaging subsystem 1700 that may be used to form UV images such as those shown in FIGS. 11, 13 and 15. Radiation from UV radiation source 112 irradiates the surface of mailpiece 19. In the embodiment pictured, UV radiation source 112 is formed from multiple UV emitting LEDs 112₁ . . . 112₇. Seven LEDs are shown for simplicity. In some embodiments, UV source 112 will be approximately as long as the width of the field of view of the UV camera formed by UV imaging subsystem and may be 10 cm or longer. In some embodiments, UV source 112 will be about 15 cm or longer. Accordingly, UV source 112 may contain more LEDs than shown to span the desired field of view and to provide the desired intensity of UV radiation. However, the specific construction of the UV source 112 is not a limitation on the invention and any suitable UV source may be used.

Radiation from radiation source 112 interacts with features, such as barcode 1710, on the surface of mailpiece 19, which causes the feature to emit light. In some embodiments, radiation from UV radiation source 112 has a spectrum with predominate components between about 40 and 400 nm. However, radiation with any suitable spectrum may be used.

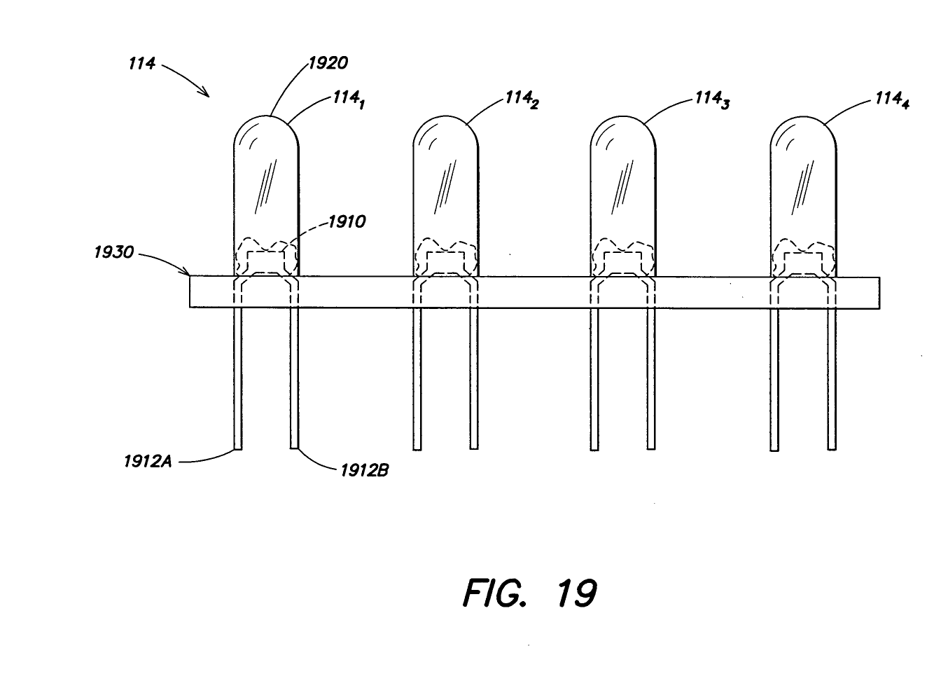

Barcode 1710 may be printed in fluorescent, phosphorescent or scintillating ink such that when it is radiated with UV light with a spectrum like that provided by UV radiation source 112 it emits visible light. However, UV imaging subsystem 1700 may be used in connection with any features that react to UV light, regardless of how formed. The light emitted from barcode 1710 is detected by detector array 1714. In the embodiment pictured, detector array 1714 is a linear array containing phototransistors 114₁ . . . 114₄. The phototransistors used to form detector array 1714 are described in greater detail below in conjunction with FIG. 19. However, the invention is not limited to the use of phototransistors. Though phototransistors facilitate the construction of a compact and low cost detector array, any suitable photon detection device may be used.

Detector array 1714 is pictured with four phototransistors for simplicity. However, in embodiments, detector array 1714 may have a length approximately equal to the field of view of the UV camera. Accordingly, detector array 1714 also may have a length of 10 cm or more and in some embodiments may be about 15 cm or longer. More than four phototransistors may be present to span the desired field of view. In some embodiments, phototransistors may be approximately evenly spaced along the length of detector array 1714 at a pitch between about 3 mm and 8.2 mm. Images formed with detector array 1714 may have a low resolution, such as between about 1 and 3.5 pixels/cm.

Light emanating from mailpiece 19 may fall in the visible light spectrum, which in some embodiments may be between about 400 nm and 700 nm. Though, in embodiments, the light may be about 650 nm or be of any other suitable wavelength.

Regardless of the specific characteristics of the light, each of the detectors is sensitive to the light emanating from mailpiece 19.

As described above, one or more filters or other components may be used to enhance the sensitivity of UV subsystem 1700. In the embodiment of FIG. 17, diffuser 1722 may be used in conjunction with UV radiation source 112. Diffuser 1722 modifies the radiation 1720 generated by UV radiation source 112 to smooth out areas of high or low intensity so that radiation 1730 irradiating the surface of mailpiece 19 is uniform. Diffusers are used in conventional photographic systems. Diffuser 1722 could be constructed from commercially available diffusion material, but any suitable material that diffuses UV radiation 1720 may be used.

Diffuser 1722 may in some embodiments additionally act as a filter to selectively pass radiation that interacts with barcode 1710. Alternatively, a separate source filter, such as filter 122, may be used instead of or in addition to diffuser 1722.

Filter 124 also may be used in conjunction with detector array 1714. Filter 124 may preferentially pass light that emanates from barcode 1710. Accordingly, light 1750 reaching detector array 1714 may have a different spectrum than light 1742 emanating from the surface of mailpiece 19.

Each of the phototransistors 114₁ . . . 114₄ outputs an electrical signal representative of the intensity of the light reaching it. In the described embodiment in which image information is processed in a digital computer, the outputs of phototransistors 114₁ . . . 114₄ are converted to digital form. In the embodiment pictured, the output of each phototransistor is coupled to a respective one of the analog-to-digital converters 1760₁ . . . 1760₄. Each analog-to-digital converter may produce a digital output of one or more bits. For a low resolution image, a small number of bits may be acceptable, which may simplify data collection and processing. However, any suitable number of bits may be used. Also, a one-to-one relationship is shown between phototransistors 114₁ . . . 114₄ and analog-to-digital converters 1760₁ . . . 1760₄. Such a depiction is shown for simplicity. Multiplexing or other approaches may be used so that the relationship between the phototransistors and analog-to-digital converters is other than one-to-one.

The digital outputs of the analog-to-digital converters 1760₁ . . . 1760₄ are routed to an image processing device, such as image server 46 (FIG. 2). In the pictured embodiment, the digital outputs are first routed to CIB 90, which provides an interface to image server 46. However, the outputs of the analog-to-digital converters may be routed through any suitable interface to any suitable device for processing.

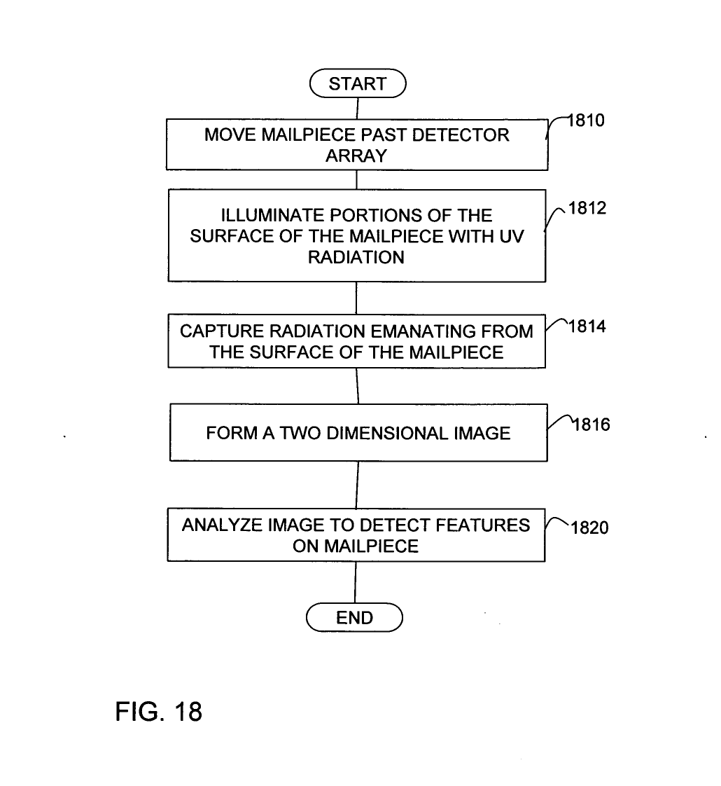

One example of the processing that may be performed on a low resolution UV image in a mail processing system using a UV imaging subsystem 1700 is provided in FIG. 18. The process begins at block 1810 where mailpieces are moved past the detector array.

At block 1812, the surface of the mailpiece is illuminated with UV radiation.

At block 1814, radiation emanating from the surface of the mailpiece is captured. Though blocks 1810, 1812 and 1814 are shown to be sequential in FIG. 18, this representation is for simplicity, and in some embodiments radiation emanating from the mailpiece will be captured while the mailpiece is being illuminated as it moves.

Motion of mailpiece 19 while an image is being captured may facilitate low cost formation of an image by scanning. In some embodiments, detector array 1714 may be a linear array. Though low cost, a linear array only can capture data on a relatively narrow, elongated region of mailpiece 19 at one time. The information captured in this fashion may be referred to as a “scan line” and by itself represents only a portion of the desired image. To image an entire surface of a mailpiece, the mailpiece may be moved relative to the UV camera to position another portion of the mailpiece in the field of view of the UV camera. In this new position, a subsequent scan line may be formed. By moving the mailpiece small amounts between the capture of scan lines, an entire surface of the mailpiece may be imaged.

At block 1816, a two dimensional image is formed from the captured radiation. In embodiments in which an image is captured by scanning, processing at block 1816 may include assembling the scan lines into an image. In some embodiments, the outputs of detector array 1714 for each scan line may be stored in computer memory in a way that organizes the data as a two-dimensional image as the data is captured. Accordingly, processing at step 1816 may be a part of other operations performed while acquiring image data. However, any suitable processing may be used to form a two-dimensional image.

At block 1820, the captured image is analyzed to identify features on the mailpiece under inspection. The specific processing performed at block 1820 may depend on the specific functions of the mail processing system in which the process is performed. For example, processing may involve detecting the orientation of the mailpiece based on the location of a scintillating, phosphorescent or fluorescent feature on the mailpiece. Such processing may be based on identifying an image of one or more of a stamp, a meter mark, an information-based indicia and an identification tag. Following such detection of a feature, the mailpiece may be reoriented to position the feature in the top, forward corner of the mailpiece. Having a two-dimensional image of an entire surface of the mailpiece available for analysis can greatly simplify locating features of interest on the surface of the mailpiece.

In some embodiments, processing at block 1820 will be based on a low resolution UV image of the mailpiece. For example, the image may be formed from a detector array having individual detectors spaced on a pitch between about 8.2 mm and 3 mm, with a resulting image resolution between about 1 and 3.5 pixels/cm. Such a low resolution allows rapid and accurate feature detection with low cost components. In other embodiments, the processing may be based on a grayscale image of the mailpiece having higher resolution, such as between about 50 and 150 pixels/cm. Such processing may result in the identification of the zip code or other portions of an address on a mailpiece, the amount of postage affixed to the mailpiece or any other information on the mailpiece.

In yet further embodiments, processing may be based on both a UV image and a grayscale image. Such processing, for example, may include use of the UV image to guide analysis of the grayscale image. For example, the UV image may be used to identify a stamp or other feature on the mailpiece. Because the location of a feature in the UV image can be readily correlated to a location in the grayscale image, processing requirements for analysis of the grayscale image may be reduced by using a correlated UV image and grayscale image formed by two imaging arrays in a single camera assembly.

Turning now to FIG. 19, additional details of an illustrative embodiment of detector array 114 are provided. As shown, detector array 114 contains multiple, discrete photodetectors. In FIG. 19, four such photodetectors 114₁ . . . 114₄ are illustrated for simplicity.

The discrete photodetectors are held on a substrate. In the embodiment of FIG. 19, that substrate may be a printed circuit board 193Q. A printed circuit board may provide both mechanical support and a mechanism to make electrical connections to each of the photodetectors. However, any suitable support may be used and electrical connections may be made in any suitable way. For example, the entire array of phototdetectors could be formed on a semiconductor wafer, which could serve as both a structural and electrically active component of the detector array.

In the embodiment of FIG. 19, each of the photodetectors 114₁ . . . 114₄ is a discrete phototransistor. Phototransistors as pictured in FIG. 19 may be procured commercially. However, any suitable phototransistor may be used.

Each phototransistor contains an active element 1910 that reacts to light. That reaction to light produces a measurable electrical effect on the signals on leads 1912A and 1912B.

The active element 1910 is enclosed within a housing. At least a portion of the housing may be transparent to allow light to reach active element 1910. The transparent portion of the housing may be shaped to act as a lens 1920. Lens 1920 make focus light on active element 1910. Because each of the photodetectors 114₁ . . . 114₄ includes a lens, the need for a lens to focus light on the detector array may be avoided, reducing the number of components in the UV imaging subsystem and further reducing the cost of the assembly.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method of processing mailpieces, comprising:
a) illuminating a surface of a mailpiece with ultraviolet radiation;
b) capturing, using an array of detectors, light emanating from the mailpiece in response to the ultraviolet radiation;
c) forming an image of the surface of the mailpiece using the captured light;
d) analyzing the image to determine whether a feature on the surface of the mailpiece responds to ultraviolet radiation; and
e) controlling processing of the mailpiece in response to analysis of the image.

2. The method of claim 1, wherein analyzing the image comprises determining whether there is a scintillating, phosphorescent or fluorescent marking on the surface of the mailpiece.

3. The method of claim 1, further comprising moving the mailpiece past an imaging assembly containing a source of ultraviolet radiation and the array of detectors

4. The method of claim 1, wherein controlling processing comprises selectively flipping the mailpiece.

5. The method of claim 1, wherein controlling processing comprises selecting a location to apply a cancellation mark.

6. The method of claim 1, wherein controlling processing comprises selecting a location to apply an identification tag.

7. The method of claim 1, wherein forming an image of the surface comprises forming an image of the entire surface of the mailpiece.

8. The method of claim 1, wherein the array comprises a linear array and the method further comprising moving the mailpiece past the linear array, whereby forming an image comprises forming a two-dimensional image.

9. A method of processing mailpieces, comprising:
a) moving a mailpiece past an array of detectors;
b) illuminating portions of a surface of the mailpiece with ultraviolet radiation as each portion of the mailpiece passes the array of detectors;
c) capturing, using the array of detectors, light emanating from the mailpiece in response to the ultraviolet radiation;
d) forming a two-dimensional image of the surface of the mailpiece using the captured light; and
e) analyzing the image to detect a feature on the surface of the mailpiece that responds to ultraviolet radiation.

10. The method of processing mailpieces of claim 9, wherein the mailpiece moves past the array of directors in a first direction and illuminating portions of the surface comprise passing radiation through a slit in a second direction, transverse to the first direction.

11. The method of processing mailpieces of claim 10, further comprising controlling processing of the mailpiece in response to analysis of the image.

12. The method of processing mailpieces of claim 11, wherein controlling further processing comprises selecting an output destination based on the location of a detected feature.

13. A mail processing system comprising an ultraviolet imaging subsystem adapted to form an image of a mailpiece in an imaging area, the ultraviolet imaging subsystem comprising:
a) a source of ultraviolet light directed toward the imaging area;
b) an array of photodetectors, each photodector being directed at the imaging area; and
c) an interface, the interface being adapted to provide an image captured by the array of photodetectors to a data processing system.

14. The mail processing system of claim 13, wherein the photodetectors in the array are spaced on a pitch of between about 3 mm and about 10 mm.

15. The mail processing system of claim 14, wherein the array has a length in excess of 10 cm.

16. The mail processing system of claim 15, wherein the array comprises a plurality of phototransistors mounted to a substrate.

17. The mail processing system of claim 16, further comprising a plurality of lenses, each lens mounted to a phototransistor of the plurality of phototransistors.

18. The mail processing system of claim 17, wherein the phototransistors respond to visible light.

19. The mail processing system of claim 18, further comprising a second array, the second array comprising a CCD array.

20. The mail processing system of claim 19, wherein the interface is adapted to provide a second image captured by the second array to the data processing system.
